(19) United States
(12) Patent Application Publication
(10) Pub. No.: US 2026/0329657 A1
(43) Pub. Date: Oct. 22, 2026

(54) ELECTRONIC APPARATUS AND CONTROLLING METHOD THEREOF

(71) Applicant: Samsung Electronics Co., Ltd., Suwon-si (KR)

(72) Inventors: Ankit JAIN, Suwon-si (KR); Kochiganti Sai Prasanna Lalitha Harsha KASYAP, Suwon-si (KR); Krishnendu MAJI, Suwon-si (KR); Mridul GUPTA, Suwon-si (KR); Siba Prasad SAMAL, Suwon-si (KR)

(21) Appl. No.: 19/699,972

(22) Filed: Jun. 5, 2026

Related U.S. Application Data
(63) Continuation of application No. PCT/KR2026/095303, filed on Mar. 27, 2026.

(30) Foreign Application Priority Data
Apr. 8, 2025 (IN) 202541034350

(51) Int. Cl. G06F 9/50

(52) U.S. Cl. CPC G06F 9/5038

(57) ABSTRACT

An electronic apparatus includes at least one processor including processing circuitry and memory storing instructions. The instructions, when executed by at least one processor individually and/or collectively, cause the electronic apparatus to: obtain user information corresponding to each of a plurality of user devices, identify a target event based on the user information, obtain a plurality of tasks corresponding to the target event, and obtain task allocation information by allocating the plurality of tasks to the plurality of user devices based on the user information.

### CROSS-REFERENCE TO RELATED APPLICATIONS

This application is a continuation of International Application No. PCT/KR2026/095303 designating the United States, filed on Mar. 27, 2026, in the Korean Ministry of Intellectual Property Receiving Office and claiming priority to Indian Patent Application number 202541034350, filed on Apr. 8, 2025, in the Indian Patent Office, the disclosures of each of which are incorporated by reference herein in their entireties.

### BACKGROUND

### Field

The disclosure relates to a Mobile Edge Computing system. For example, the present disclosure relates to redundancy removal and resource allocation in a connected network system.

### Description of Related Art

In the contemporary digital landscape, multiple users often operate in a connected environment to achieve common objectives. Despite the advancements in technology, several inefficiencies persist in coordinating activities among these users. These inefficiencies manifest in various forms and can significantly hinder the overall productivity and effectiveness of achieving common objective.

One of the issues is the lack of coordination among users performing activities. When multiple users are involved in planning and executing tasks for a common event, such as organizing a birthday party, they may inadvertently duplicate efforts. For instance, if User 1 and User 2 are both tasked with searching for party decoration items within a budget of Rs 3000, they may end up searching for the same items on the same application. This redundancy not only wastes time but also fails to leverage the potential for a more streamlined and efficient task division.

Further, the manual division of tasks among users often does not consider individual user skills, subscriptions, and the capabilities of their respective devices. This random assignment of tasks can lead to suboptimal outcomes. For example, when a group of users plans to watch a movie and order food, User 1 might search for a movie online, User 2 might order food, and User 3 might set the ambiance. If User 3 has a subscription that offers additional benefits for food orders, but this is not taken into account, the group misses out on potential advantages. Thus, the lack of a systematic approach to task allocation based on user capabilities and subscriptions results in inefficiencies.

Moreover, there is often no synchronization between users upon task completion. In scenarios where a group is planning to book a cab with the best fare and fastest arrival, different users might use different applications to search for options. For instance, User 1 might search for a cab on Application 1, User 2 might search for both cabs and autos on Application 2, and Users 3 and 4 might check ONDC-based cab aggregators. If one user completes the task in a way that does not align with the preferences of the others, and this information is not communicated effectively, it can lead to dissatisfaction and further delays.

These challenges highlight the need for improved methods and systems to coordinate activities, allocate tasks efficiently, and synchronize the completion of tasks in a connected environment.

Hence it is desirable to address the above-mentioned problem and disadvantages or at least provide a useful alternative.

### SUMMARY

Embodiments of the disclosure may provide redundancy removal and resource allocation in a connected network system.

Embodiments of the disclosure may determine a common objective associated with redundancy removal and resource allocation in a connected network system.

Embodiments of the disclosure may determine redundancy parameters that the common task and sub-tasks will have when divided among the group of people.

Embodiments of the disclosure may generate and distribute sub-tasks associated with the common objectives to users according to the resource availability and their core competency for the sub-task based on past usage.

Embodiments of the disclosure may deploy smart strategies (to support collaboration, sync up, etc.) to complete the distributed tasks for the users.

Embodiments of the disclosure may modify and redistribute sub-tasks associated with the common objective based on how the user performed the current activity.

According to an example embodiment, an electronic apparatus includes: at least one processor, including processing circuitry, and memory storing instructions. The instructions, when executed by at least one processor, individually and/or collectively, cause the electronic apparatus to: obtain user information corresponding to each of a plurality of user devices, identify a target event based on the user information, obtain a plurality of tasks corresponding to the target event, and obtain task allocation information by allocating the plurality of tasks to the plurality of user devices based on the user information.

The target event may be a common event identified from the plurality of user devices.

The user information may include at least one of activities of the plurality of user devices or parameters of users.

The activities may be data obtained while users use the plurality of user devices, and the parameters may be data related to a user or a user device.

The instructions, when executed by at least one processor, individually and/or collectively, may cause the electronic apparatus to: identify the target event based on the activities of the plurality of user devices, and allocate the plurality of tasks to the plurality of user devices based on the parameters of users.

The instructions, when executed by at least one processor, individually and/or collectively, may cause the electronic apparatus to: identify at least one redundant activity from the at least one of activities, remove the at least one redundant activity from the at least one of activities, and identify the target event based on the activities from which the redundant activity is removed.

The electronic apparatus may include a communication interface, comprising communication circuitry. The instructions, when executed by at least one processor. individually and/or collectively, may cause the electronic apparatus to identify the plurality of user devices based on a communication protocol corresponding to the communication interface.

The electronic apparatus may include a display. The instructions, when executed by at least one processor, individually and/or collectively, may cause the electronic apparatus to control the display to display the task allocation information.

The instructions, when executed by at least one processor, individually and/or collectively, may cause the electronic apparatus to: obtain first user information corresponding to a first user device of a first user, obtain second user information corresponding to a second user device of a second user, and identify the target event based on the first user information and the second user information.

The instructions, when executed by at least one processor, individually and/or collectively, may cause the electronic apparatus to: obtain a first task and a second task corresponding to the target event, allocate the first task to the first user device, allocate the second task to the second user device, and obtain the task allocation information including a first result of allocating the first task to the first user device and a second result of allocating the second task to the second user device.

According to an example an embodiment, a method for controlling an electronic apparatus include: obtaining user information corresponding to each of a plurality of user devices, identifying a target event based on the user information, obtaining a plurality of tasks corresponding to the target event, and obtaining task allocation information by allocating the plurality of tasks to the plurality of user devices based on the user information.

Target event may be a common event identified from the plurality of user devices.

The user information may include at least one of activities of the plurality of user devices or parameters of users.

The activities may include data obtained while users use the plurality of user devices, and the parameters may be data related to a user or a user device.

The identifying the target event may include identifying the target event based on the activities of the plurality of user devices, and the obtaining the task allocation information may include allocating the plurality of tasks to the plurality of user devices based on the parameters of users.

According to various example embodiments, the disclosure provides a method for redundancy removal and resource allocation in a connected network system. The method includes: identifying, by a central apparatus, activities carried out by multiple users on one or more applications on multiple electronic devices and user parameters related to the activities within the connected network system. These multiple electronic devices are connected to the central apparatus.

The method may include: predicting, by the central apparatus, a common event being planned by the users based on a first set of specified parameters. This first set of specified parameters includes the one or more applications used by the multiple users on multiple electronic devices, activities carried out by the multiple users on the one or more applications, and inputs provided on the one or more applications.

The method may include: determining, by the central apparatus, a set of tasks necessary for collectively performing the common event by the users of the connected network system. Each task of the set of tasks may then be allocated by the central apparatus to a set of optimal electronic devices of the multiple electronic devices of the multiple users based on a second set of parameters. This second set of parameters includes the competency of the user, the resource availability on the electronic device, the application capability of the one or more applications of the multiple electronic devices of the multiple users, and the proficiencies of each user in particular activities.

The method may include: displaying, by the central apparatus, a notification to perform the set of tasks concurrently across the set of optimal electronic devices using the optimal application to complete the at least one common event.

According to an example embodiment a central apparatus for redundancy removal and resource allocation in a connected network system is provided. The central apparatus includes: at least one processor, comprising processing circuitry, and an activity management controller comprising circuitry communicatively coupled to the processor. The activity management controller is configured to: identify activities carried out by multiple users on one or more applications on multiple electronic devices, as well as user parameters related to these activities within the connected network system. These multiple electronic devices are connected to the central apparatus.

The activity management controller may be configured to: predict common events being planned by the users based on a first set of pre-defined parameters. These parameters include the applications used by the multiple users on multiple electronic devices, the activities carried out by the users on these applications, and the inputs provided on the applications. The activity management controller may be configured to determine a set of tasks necessary for collectively performing the common event by the users of the connected network system.

The activity management controller may be configured to allocate each task of the set of tasks to a set of optimal electronic devices among the multiple electronic devices of the users, based on a second set of parameters. These parameters include the competency of the user, the resource availability on the electronic device, the application capability of the applications on the multiple electronic devices, and the proficiencies of each user in particular activities. The activity management controller may be configured to control the central apparatus to display a notification to perform the set of tasks concurrently across the set of optimal electronic devices using the optimal application to complete the common event.

These and other aspects of various example embodiments herein will be better appreciated and understood when considered in conjunction with the following description and the accompanying drawings. It should be understood, however, that the following descriptions, while indicating various example embodiments and numerous specific details thereof, are given by way of illustration and not of limitation. Many changes and modifications be made within the scope of the disclosure.

### BRIEF DESCRIPTION OF THE DRAWINGS

The above and other aspects, features and advantages of certain embodiments of the present disclosure will be more apparent from the following detailed description, taken in conjunction with the accompanying drawings, throughout which like reference letters indicate corresponding parts in the various figures, and in which:

FIG. 1A is a block diagram illustrating an example configuration of a central apparatus for redundancy removal and resource allocation in a connected network system according to various example embodiments.

FIG. 1B is a block diagram illustrating an example configuration of an activity management controller for redundancy removal and resource allocation in a connected network system according to various example embodiments.

FIG. 1C is a block diagram illustrating an example configuration of a collective group task delivery model of an activity management controller to determine collective group tasks carried out by multiple users according to various example embodiments.

FIG. 1D is a block diagram illustrating an example configuration of an affordance insight assembler model of an activity management controller to trigger insights on tasks being done and areas that can be helped in according to various example embodiments.

FIG. 1E is a block diagram illustrating an example configuration of a core and user comprehension model of an activity management controller to determine user competency and a common event performed by multiple users according to various example embodiments.

FIG. 1F is a block diagram illustrating an example configuration of a step task generator and assigner model of an activity management controller to determine sub-tasks to perform a common event and assign sub-tasks to multiple users according to various example embodiments.

FIG. 2 is a flowchart illustrates an example method for redundancy removal and resource allocation in a connected network system according to various example embodiments.

FIG. 3A is a diagram illustrating an example scenario of determining collective group tasks carried out by multiple users using a collective group task discovery model according to various example embodiments.

FIGS. 3B, 3C and 3D are diagrams illustrating example scenarios of tasks performed by an affordance insight assembler model according to various example embodiments.

FIGS. 3E and 3F are diagrams illustrating example scenarios of tasks performed by a core and user comprehension model and a step task generator and assigner model according to various example embodiments.

FIGS. 4A, 4B, 4C, 4D, 4E and 4F are diagrams illustrating example scenarios for redundancy removal and resource allocation while multiple users are trying to perform cab booking services according to various example embodiments.

FIG. 5 is a flowchart illustrating an example method for obtaining task allocation information according to various example embodiments.

### DETAILED DESCRIPTION

It may be noted that, to the extent possible, like reference numerals have been used to represent like elements in the drawing. Furthermore, those of ordinary skill in the art will appreciate that elements in the drawing are illustrated for simplicity and may not necessarily have been drawn to scale. For example, the dimensions of some of the elements in the drawing may be exaggerated relative to other elements to improve the understanding of aspects of the disclosure. Further, the elements may have been represented in the drawing by conventional symbols, and the drawings may show only those specific details that are pertinent to understanding the disclosure so as not to obscure the drawing with details that will be readily apparent to those of ordinary skill in the art having the benefit of the description herein.

The disclosure is described and illustrated in terms of blocks that carry out a described function or functions. These blocks, which are referred to herein as managers, units, modules, hardware components, or the like, are physically implemented by analog and/or digital circuits such as logic gates, integrated circuits, microprocessors, microcontrollers, memory circuits, passive electronic components, active electronic components, optical components, hardwired circuits, and the like, and may optionally be driven by firmware and software. The circuits, for example, may be embodied in one or more semiconductor chips or on substrate supports such as printed circuit boards and the like. The circuits of a block may be implemented by dedicated hardware or by a processor (e.g., one or more programmed microprocessors and associated circuitry) or by a combination of dedicated hardware to perform some functions of the block and a processor to perform other functions of the block. Each block of the various embodiments may be physically separated into two or more interacting and discrete blocks without departing from the scope of the disclosed method. Likewise, the blocks of the various embodiments may be physically combined into more complex blocks without departing from the scope of the disclosed method.

The accompanying drawings are used to help easily understand various technical features, and it is understood that the various embodiments presented herein are not limited by the accompanying drawings. As such, the disclosed method is construed to extend to any alterations, equivalents, and substitutes in addition to those which are particularly set out in the accompanying drawings. Although the terms “first,” “second,” etc. are used herein to describe various elements, these elements are not limited by these terms. These terms are generally used to distinguish one element from another.

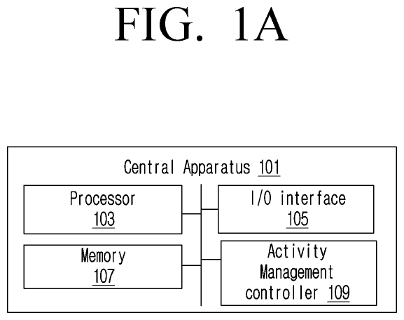

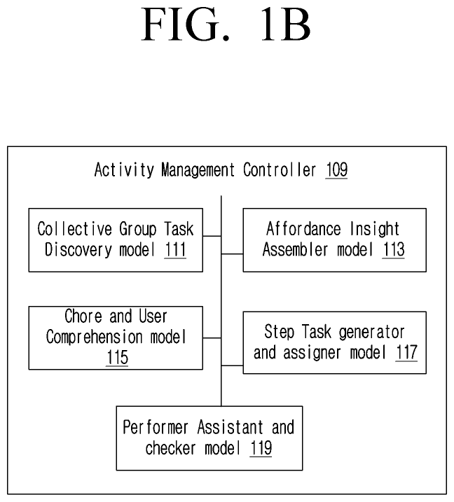

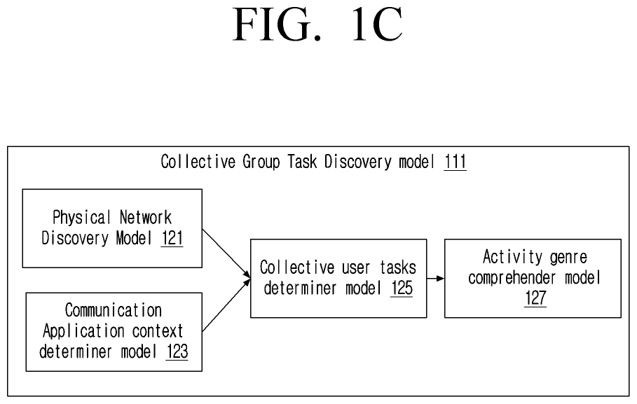

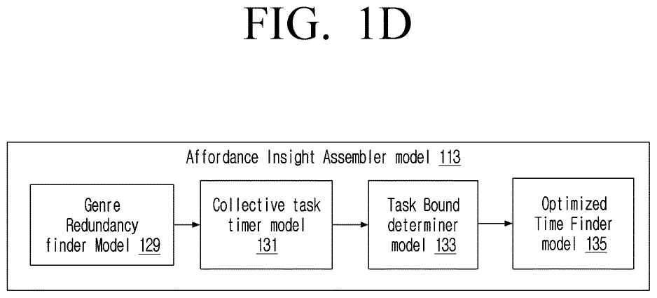

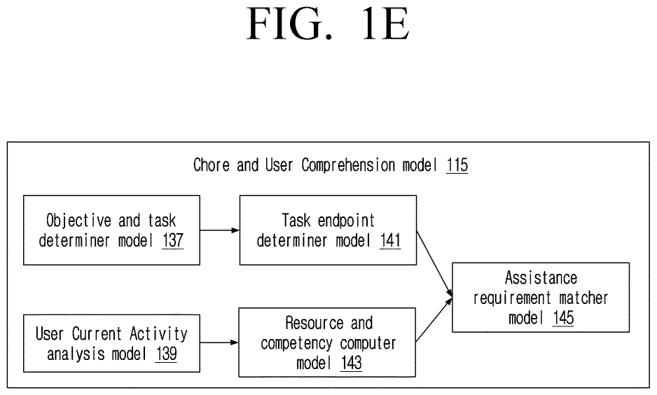

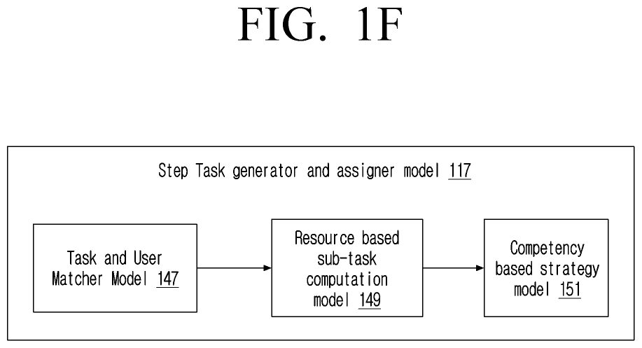

Referring now to the drawings and for example to FIGS. 1 to 4, where similar reference characters denote corresponding features consistently throughout the figures, these are shown various example embodiments.

FIG. 1A is a block diagram illustrating an example configuration of a central apparatus (101) for redundancy removal and resource allocation in the connected network system, according to various example embodiments disclosed herein.

The central apparatus (101) may refer, for example, to a device that is responsible for coordinating, managing and optimizing the operation of multiple connected electronic devices in a multi user environment. In an embodiment, the central apparatus can include, but not limited to a central server or control system in a cloud environment. In an embodiment, the central apparatus can include, but not limited to a central hub or gateway in a IoT system. In an embodiment, the central apparatus can include, but not limited to access point in a WiFi networks. The central apparatus (101) includes a processor (e.g., including processing circuitry) (103), a memory (107), an I/O interface (e.g., including circuitry and/or executable program instructions) (105), and an activity management controller (e.g., including various circuitry and/or executable program instructions) (109). Further, the processor (103) of the central apparatus (101) communicates with the memory (107), the I/O interface (105), and the activity management controller (109). The processor (103) is configured to execute instructions stored in the memory (107) and to perform various processes. The processor (103) can include one or a plurality of processors, can be a general-purpose processor such as a central processing unit (CPU), an application processor (AP), or the like, a graphics-only processing unit such as a graphics processing unit (GPU), a visual processing unit (VPU), and/or an Artificial Intelligence (AI) dedicated processor such as a neural processing unit (NPU). Thus, the processor (103) may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The memory (107) of the central apparatus (101) includes storage locations that can be addressed through the processor (103). The memory (107) is not limited to volatile or non-volatile memory and can include one or more computer-readable storage media. Non-volatile storage elements such as magnetic hard disks, optical discs, floppy discs, flash memories, EPROM, or EEPROM memories can also be included in the memory (107). Further, the memory (107) of the central apparatus (101) can store various information received from multiple electronic devices. The information can include, but not related to the data running on one or more applications of the multiple electronic devices of multiple users. The memory (107) of the central apparatus stores activities carried out by multiple uses on one or more applications on multiple electronic devices, proficiencies of each user in particular activity, a common event associated with the multiple users, a set of tasks related to the common event, available resource on the multiple electronic devices, application capability of the one or more applications, and competencies of the multiple users.

The I/O interface (105) may include various circuitry and/or executable program instructions and transmits information between the memory (107) and external peripheral devices, which are input-output devices associated with the central apparatus (105). The I/O interface (105) receives various information from the multiple electronic device present in a connected environment. This information can include, but is not limited to, data running on one or more applications of the multiple electronic devices of multiple users.

The activity management controller (109) may include various circuitry and communicates with the I/O interface (105) and memory (107) for redundancy removal and resource allocation in a connected network system. The activity management controller (109) may include an innovative hardware that is realized through the physical implementation of both analog and digital circuits, including logic gates, integrated circuits, microprocessors, microcontrollers, memory circuits, passive and active electronic components, as well as optical components.

The activity management controller (109) of the central apparatus (101) identifies activities carried out by multiple users on one or more applications on multiple electronic devices, and user parameters related to the activities within the connected network system. For example, the electronic devices can be consumer electronic devices such as smartphone, laptop, smartwatch, television and the like. In an embodiment, the electronic device can be a home appliances such as refrigerator, washing machine, stove and the like. The multiple electronic devices is connected to the central apparatus (101). The activity management controller (109) predicts common event being planned by the users based on the first set of pre-defined (e.g., specified) parameters. The first set of pre-defined parameters includes the one or more applications used by the multiple users on multiple electronic devices, activities carried out by the multiple users on the one or more applications, and inputs provided on the one or more applications. The activity management controller (109) determines the set of tasks necessary for the collectively performing the common event by the users of the connected network system. The activity management controller (109) allocates each task of the set of tasks to a set of optimal electronic devices of the multiple electronic devices of the multiple users based on a second set of parameters. The second set of parameters may include, for example, the competency of the user, the resource availability on the electronic device, application capability of the one or more applications of the multiple electronic devices of the multiple users, and the proficiencies of each user in particular activities. The activity management controller (109) displays the notification to perform the set of tasks concurrently across the set of optimal electronic devices using the optimal application to complete the common event. For example, the notification can be provided as the text notification displayed on the screen of the electronic devices, voice notification and the like.

The central apparatus (101) identifies the activities carried out by multiple users on one or more applications on multiple electronic devices within the connected network system includes. For example, the activities carried out by the multiple users can include, but not limited to searching for speakers on shopping application, shopping groceries and speakers in shopping applications, searching arty games to play and preparing invitee list. Further, the central apparatus (101) discovers the multiple near-by electronic devices using network protocols. The network protocols can include, but not limited to the Wi-fi, Bluetooth, NFC, and a UWB. The central apparatus (101) determines the conversations performed between multiple users about activities using the application data and contacts list stored in the electronic device. For example, the conversations can be performed between the multiple users over phone calls, text messages and the like. The central apparatus (101) determines the activities carried out by each user of the multiple users in the one or more applications based on the conversation about the activities, and past usage of the one or more applications associated with the activity by the user over a period of time. For example, the user is talking about food in the party for which the determined action can be ordering food. Further, the user's previous usage of apps in the genre, like food ordering apps and user's inputs on that application are used to confirm the activity performed by the user. The past usage of the one or more application can include, but not limited to inputs provided on the one or more applications, capabilities of the one or more applications.

The central apparatus (101) may identify the redundant activity from the one or more determined activities based on the one or more applications used by the multiple users for performing the activities. The central apparatus (101) determines the time period to perform the redundant activity by multiple users, and correlation between the multiple users. The central apparatus (101) determines the input/pre-conditions that is required by the multiple users to perform activities and the user for which the input should be asked for suggestions and task helping. Further, the central apparatus (101) determines a current time based on redundant activities and derives the optimized time in which the activities can be performed when redundant activities are removed. Further, the central apparatus (101) derives the optimized tasks by removing the redundant activities from activities carried out by multiple users in the one or more applications.

The central apparatus (101) may predict the common event being planned by the users by inputting the set of pre-defined parameters into the first AI model. For example, the first AI model can include, but not limited to Long Short-Term model (LSTM), Recurring Neural Network model (RNN). Each model may include various processing circuitry and/or executable program instructions configured to perform various of the recited/disclosed functions The central apparatus (101) inputs the set of pre-defined parameters to the first AI model to determine the common event being planned by the multiple users. The set of pre-defined parameters can include, but not limited to the one or more applications used by the multiple users on multiple electronic devices, activities carried out by the multiple users on the one or more applications, the conversations performed between multiple users about activities, and inputs provided on the one or more applications. Further, the central apparatus (101) determines the common event based on the activities performed by the multiple users, the one or more applications used by the multiple users, intent of the one or more applications that are being used, and the inputs provided on the one or more applications by the multiple users.

The central apparatus (101) may determine the endpoint of the activities carried out by the multiple users associated with the common event. For example, the endpoint can include, but not limited to “buying items” for the activities such as buying groceries, buying electronics and the like. Further, the central apparatus (101) analyses the user actions performed by the multiple users for current activity performed on the electronic device. For example, the user actions are analyzed based on the keyboard presses and User interface touches. Further, the central apparatus (101) determines the resources available on the electronic device associated with each of the user and competency of each of the user based on past actions/user actions performed by the user and the method of doing the user actions. For example, the resources can include, but not limited to the multi-view feature of the electronic device, taskbar, foldable screen, CPU speed, RAM consumption levels, and input hardware. The central apparatus (101) determines the set of tasks for collectively performing the common event for which the assistance is required based on the resource availability and competency of each of the user.

The central apparatus (101) may match the set of tasks with the multiple users based on competency of the user. The central apparatus (101) determines each task that is to be allocated to the multiple users based on the resource availability. The central apparatus (101) determines the application capability of the one or more applications running in on the multiple electronic device based on the aggregate data from multiple sources, the subscriptions for applications, application passes, application features, application category. The central apparatus (101) allocates each task of the set of tasks to the multiple users associated with the electronic devices based on the competency of the user, the resource availability on the electronic device and the application capability of the one or more applications of the multiple electronic devices of the multiple users. Further, the central apparatus (101) determines the strategies required for each task allocated to the user.

The conventional technique discloses a task flow identification based on user intent. In yet another convention technique discloses an application recommendation based detected triggering events.

However, in contrast to the conventional technique, the disclosure determines the redundant tasks carried out my multiple users. The disclosure suggests an appropriate action to each specific user who are performing a common goal. The disclosure determines multiple user scenario working towards a common goal and classifies suggestions regarding the type of keywords, actions to be performed by the user.

FIG. 1B is a block diagram illustrating an example configuration of the activity management controller for redundancy removal and resource allocation in a connected network system, according to various example embodiments.

The activity management controller (109) includes a collective group task discovery model (111), an affordance insight assembler model (113), a chore and user comprehension model (115), a step task generator and assigner model (117) and a performer assistant and checker model (119), each of which may include various circuitry and/or executable program instructions configured to perform various of the recited/disclosed functions.

In the disclosure, consider a scenario where multiple users are present in a connected environment and are performing several activities to achieve a common goal in the multiple electronic devices. Each of the electronic device can be associated with each user. The connected environment refers to a network of multiple electronic devices that are linked to each other through local networks or wireless technologies such as Wi-Fi, Bluetooth or IoT protocols. The multiple electronic devices in the connected environment can communicate, share data and work together to provide certain functionalities and automation. For example, the collective group task discovery model (111) of the activity management controller (109) identifies the activities performed by multiple users in the one or more electronic devices. The electronic device can be, but not limited to a portable electronic devices such as mobile phones, XR devices, Voice assistants, home appliances such as fridge, refrigerator, and Internet of Things (IoT) devices. The activities performed in the one or more electronic device can include, but not limited to shopping for items.

On an e-commerce application, providing a search query on web browsers, and community formation on social media applications. For example, the activities performed can include, but not limited to searching for speakers on the e-commerce application, searching groceries and speakers on the e-commerce application, searching party games to play and forming invitees list. Upon identifying, the collective group task discovery model (109) detects group of users possibly doing the particular activity and verifies whether the activities performed is consistent among the multiple users.

The affordance insight assembler model (113) analyses activities performed by the group of users (hereinafter multiple users is interchangeably used as “group of users”). The affordance insight assembler model (113) provides and triggers insights to the users on the respective electronic devices related to activities being performed on the electronic device. For example, the affordance insight assembler model (113) can trigger a task manger indicating redundant activities performed by the group of users, and usual time taken for completing the redundant activities, estimated smart time that can be taken for performing the activity without encountering redundancy. The affordance insight assembler model (113) can trigger a task manger by asking the inputs required for performing the activity. For example, the task manager cans be triggered by asking for budget range searching by the user for purchasing speakers and discounts expected by the users on the speakers.

Upon receiving, the inputs from the users on their respective electronic device, the chore and user comprehension model (115) determines the common event performed by the group of users based on the activities identified that are performed by the users on the multiple electronic devices, redundant activities performed by the group of users, user inputs in response to the trigger of task manager, and activity genre. The determination is performed using a first Artificial Intelligence (AI) model, for which a first set of parameters are provided as the input. The AI model learns from the first set of parameters provided and generates an output of the common event performed by the group of users. For example, the common event can be “planning for a birthday party” by the group of users, for the identified activities being “searching for speakers on the e-commerce application, searching party games to play and forming invitees list”.

Upon determining the common event, the step task generator and assigner model (117) determines the set of tasks that needs to be performed for performing the common event by the group of users. The step task generator and assigner model (117) divide the identified activities into set of tasks that can reduce the redundancy by eliminating the redundant activities performed by the multiple users. Further, the step task generator and assigner model (117) assign each of the task to each user among the group of user based on the competency of the user, the resource availability on the electronic device, application capability of the one or more applications of the multiple electronic devices of the multiple users, and the proficiencies of each user in particular activities.

The proficiencies of the user may refer, for example, to skills and knowledge of the users in navigating and utilizing features and applications of the electronic device. For example, the proficiencies of the user can be “the user having connections with many other users”, for which the user can be assigned a task of forming invitees list for the birthday party, Use of filters provided by the application to search faster, Having Search options on multiple apps/websites, Search for coupons, discounts and reviews before purchasing, Checking Reviews and feedback from consumers, Vocabulary used for searching terms and the like. Similarly, the competencies of the user refer to the specific skills and abilities that enables the user to effectively user their associated electronic device. The competencies of the user can include, but not limited to technical skills, using different messaging applications, and emails to interact effectively with other users, competency in using variety of application for productivity, entertainment or learning. The competencies contribute to users overall efficiency and effectiveness when interacting with other users. For example, the competencies of the user can be, but not limited to cost range, and multiple-applications.

The resource availability on the electronic device may refer, for example, to access and availability of various tools, applications and other features that enhance functionality and usability of the electronic device, screen size, hardware specifications such as RAM, software features such as pop-up window, split window and the like. The resources of the electronic device can include, but not limited to cloud storage (eg: google drive, dropbox, iCloud and the like), connectivity options (eg: Wi-Fi, mobile data, Bluetooth and the like), device features (cameras, GPS, sensors, voice assistant and the like), settings and customizations on the electronic device.

The application capability of the one or more applications refers to the specific functions and features that the application can perform. For example, the application capability can include, but not limited to membership available for the application, and multi-window applications.

The performer assistant and checker model (119) provides suggestions on keywords, sorting, overlays for performing the tasks to the users.

FIG. 1C is a block diagram illustrating an example configuration of the collective group task delivery model of activity management controller to determine collective group tasks carried out by multiple users, according to various example embodiments.

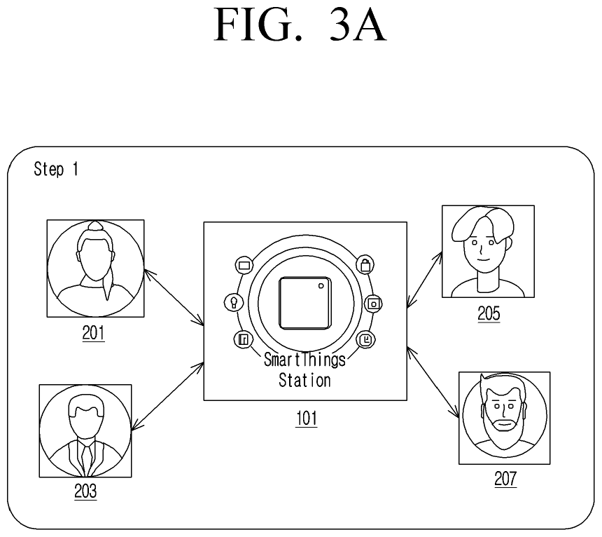

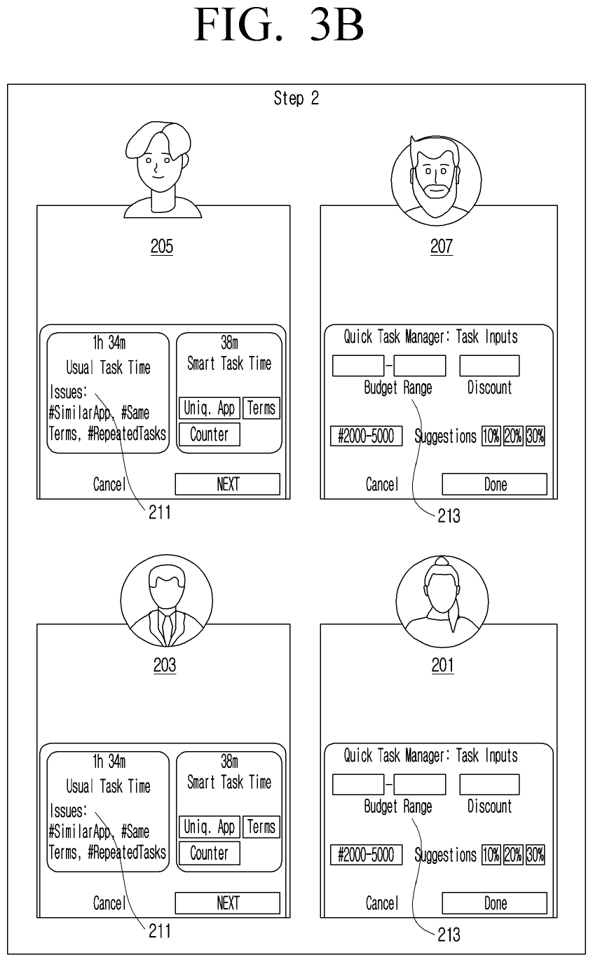

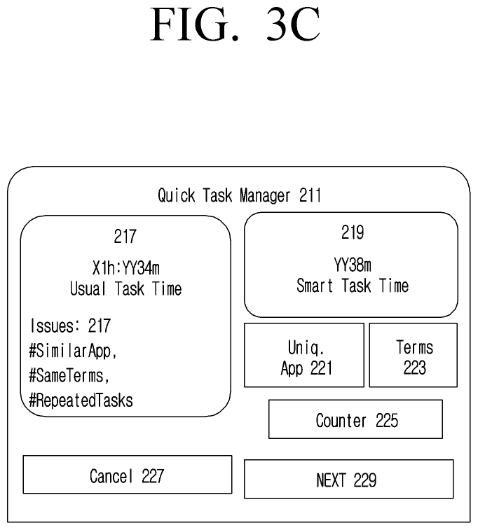

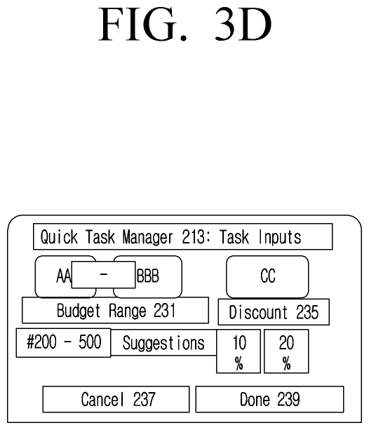

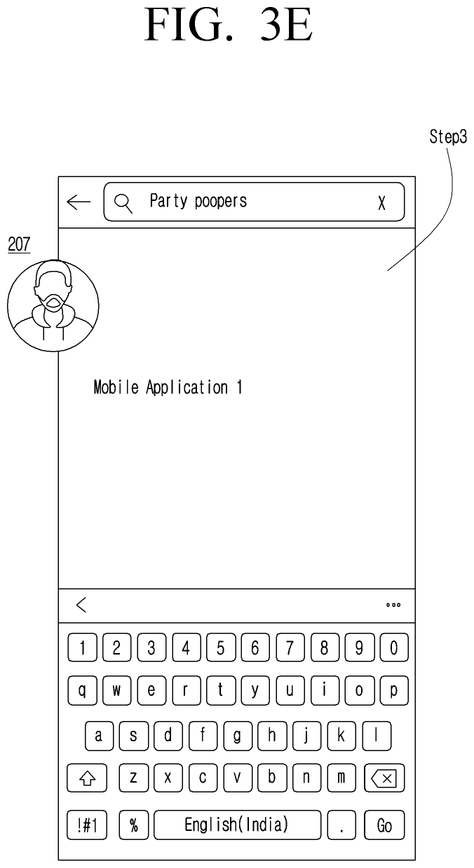

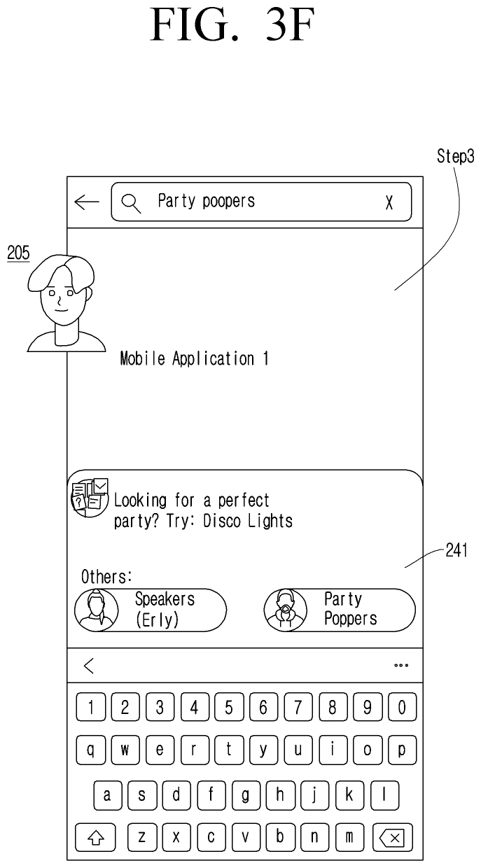

The collective group discovery model (111) includes a physical network discovery model (121), a communication application context determiner model (123), a collective user tsks determiner model (125), an activity genre comprehender model (127), each of which may include various circuitry and/or executable program instructions configured to perform various of the recited/disclosed functions. For example, the physical network discovery model (121) discovers the near-by multiple electronic devices using network protocols as shown and described in greater detail below with reference to FIG. 3A. The modules in the electronic devices can interact with the other electronic devices to determine whether they are nearby to each other. For example, the network protocols can include, but not limited to Wi-Fi, Bluetooth, Near Field Communication (NFC), Ultra Wide Band (UWB). The near-by electronic devices can include, but not limited to mobile device, television (TV), and fridge. The hub-core modules in the fridge, TV, hub device can further aid in discovery of the mobile devices working under the same network or application.

The communication application context determiner model (123) determines the application data associated with the applications used in the electronic device, contacts list with which the users of the electronic device is in conversation for a particular task. For example, the application context determiner model (123) determines that the communication between the users of the electronic device is done in voice call, video call, and voice or video calls using web applications.

The determined users from the collective group discovery model (111) and the determined application data and contacts list from the communication application context determiner model (123) is inputted to the collective user tsks determiner model (125). Further, the collective user tasks determiner model (125) determines activities performed by the users in the electronic device based on the network protocols, the application data, the contacts list, conversations performed between the multiple users, past activities performed by the user over a period of time. For example, the activities performed by the user can include, but not limited to searching for speakers on an e-commerce website, searching groceries, searching party games to play, and making invitees list.

The activity genre comprehender model (127) determines the switching between the various applications made by each of the user on the electronic device, keyboard inputs provided by each of the user in the electronic device. Further, activity genre comprehender model (127) determines the activity genre that each of the users are trying to achieve based on the genre and capabilities of the applications the user is using on the electronic device. For example, the activity genre can include, but not limited to shopping utilities, shopping food items, shopping, electronics, shopping games, and community formation.

The collective group task discovery model (111) can provide an output of the users associated with electronic device, activities performed on the electronic device, interaction medium between the electronic device used for communicating, activity genre as shown in below table 1:

TABLE 1

| | Interaction | | |
|---|---|---|---|
| Users | Medium | Current Activity | Activity Genre |
| Anand | In-Person (UWB / | Searching for | Shopping Utilities |
| | Bluetooth) | speaker on amazon | |
| Basu | In-Person (UWB / | Searching groceries | Shopping Food items |
| | Bluetooth) | and speakers | and electronics |
| Chitu, | Video Call / | Searching party | Shopping games, |
| Dave | Voice Call | games to play and | Community |
| | | invitees list | formation |

FIG. 1D is a block diagram illustrating an example configuration of the affordance insight assembler model of activity management controller to trigger insights on task being done and areas that can be help in, according to various example embodiments.

The affordance insight assembler model (113) receives the output provided from the collective group task discovery model (111). The affordance insight assembler model (113) includes a genre redundancy finder model (129), a collective task timer model (131), a task bound determiner model (133), an optimized time finder model (135), each of which may include various circuitry and/or executable program instructions configured to perform various of the recited/disclosed functions. The affordance insight assembler model (113) derives data on the activities carried out currently by the user on the respective electronic devices and provides the insights on the areas it can help the user in performing the activities. For example, data derived can include, but not limited to the applications that the users are currently operating on the electronic device.

For example, the genre redundancy finder model (129) determines applications being currently used by the users on the electronic devices and a market data. The market data refers to global statistics on how much time on an average a user performing the step/activity will take to complete it in the app. Further, the genre redundancy finder model (129) determines possible redundancies among the activities performed by the multiple users based on the determined applications and the market data.

The collective task timer model (131) determines a total amount of time for which the activities performed by the users is bound to be completed based on the activity genre, correlation between the users, global data and a past data. The global data is the data sourced from users in the demographic and past data is the user's data of performing the activity in recent user's past. For example, in general on an average the users take 23 mins to order food, the specific user from previous app usage takes 35 mins on average to order food.

The task bound determiner model (133) determines the inputs that is required by the user to perform the activity, and which of the user should be asked for the input for suggestions to perform the activity.

The optimized time finder model (135) determines an optimized time in which the redundancies between the activities can be addressed based on the total amount of time for which the activities performed by the users and the possible redundancies among the activities performed by the multiple users.

In an embodiment, the affordance insight assembler model (113) may also be referred to as triggering the insights on the redundant activities, similar applications used for performing the activity by other users, similar terms used by other users for performing the activity as illustrated and described in greater detail below with reference to FIG. 3B. The affordance insight assembler model (113) indicates the total of amount of time taken to complete the activity in the presence of redundancy and optimized time that can be taken to complete the activity without redundancy. Also, the affordance insight assembler model (113) provides the triggers on the inputs that is required from the users to perform the activity as illustrated and described in greater detail below with reference to FIGS. 3C and 3D.

The affordance insight assembler model (113) can provide an output of non-smart time (total time taken to complete the activity), possible redundancies, optimized time, task assistance/suggestions, initial inputs required by the user as shown in below table 2:

TABLE 2

| | | Smart | | |
|---|---|---|---|---|
| Non-Smart | Possible | Timer | Task | Initial Input |
| Time | Redundancies | (Approx) | Assistance | Req. |
| 4 h 56 m | ) Same App | 1 h 30 m | ) Diff App, | )Budget |
| | ) Similar | | ) Term | Estimation |
| | keyTerms | | Suggestions | |
| | ) Done task | | and Tracking, | |
| | alignment | | ) Task Counter | |
| | | | etc. | |
| 1 h 23 min | ) Same Filters | 30 m | ) Filter | ) Discount |
| | ) Same App | | Permutations | Range |
| | ) Similar Items | | ) No Revisits | ) Price |
| | | | on items | Range |
| | | | ) Common | |
| | | | Wishlist | |

FIG. 1E is a block diagram illustrating an example configuration of the chore and user comprehension model of activity management controller to determine user competency and the common event performed by multiple users, according to embodiments disclosed herein.

The chore and user comprehension model (115) receives the output obtained from the affordance insight assembler (113) as an input. Further, the chore and user comprehension model (115) determines the common event and the set of necessary tasks that is required to carry out the common event. The set of tasks that is required to carry out the common event is a subset of the determined activities performed by the multiple users on the one or more electronic devices. The common event is a collaborative task performed by the multiple users and the collaborative task is divided into set of tasks. Also, the chore and user comprehension model (115) determine the method in which the set of tasks are performed and the objective associated with each task.

The chore and user comprehension model (115) includes an objective and task determiner model (137), user current activity analysis model (139), task endpoint determiner model (141), a resource and competency computer model (143), and a assistance requirement matcher model (145), each of which may include various circuitry and/or executable program instructions configured to perform various of the recited/disclosed functions. For example, the objective and task determiner model (137) determine the set of tasks that the multiple users are performing on their respective electronic devices based on the one or more applications used by the multiple users, intent of the applications and the keyboard inputs that are provided by the multiple users for performing the tasks. The intent of the application is to fulfill specific user needs or specific problems by offering services, information, entertainment through an accessible and user-friendly interface. For example, the intent of social networking applications aims to connect with people and communicate with people. Similarly, the entertainment applications aim to entertain the users through easy access to digital content. The e-commerce applications allow the users to browse, purchase and simplifies shopping and purchase transactions. The keyboard inputs that are provided by the multiple users can be the various search terms that are used by the user to perform a particular task, touch on the user interface made by the user on the electronic device and the like.

The task endpoint determiner model (141) determines an end-points of the each of the task performed by the multiple users. Further, the task endpoint determiner model (141) determines the common objective of each task based on the end-point of the task. For example, the for the tasks such as shopping groceries, electronics the task end-point is buying items. Similarly, for the task of invites list the task end-point is send invites. Further, the common objective of the tasks like buying items, shopping groceries and send invites can be “party arrangements at home”. An example output provided by the task end-point determiner model may be as shown in below Table. 3:

TABLE 3

| | | Exact Task |
|---|---|---|
| Objective | Task Endpoints | Assistance |
| Party Arrangements | 1. Buy Items: groceries, | ) Diff App, |
| in House | Electronics | ) Term Suggestions |
| | 2. Send invites | |
| Hangout at some | 1. Restaurant selection | ) Filter Permutations |
| place | 2. Cab Selection | ) No Revisits on |
| | | items |

The user current activity analysis model (139) analyses the current actions that the user is completing to determine the current task the user is performing. The current actions of the user can include, but not limited keyboard inputs such as user is searching for speakers to buy, searching term such as “Bluetooth speaker” on various mobile applications, keyboard inputs forms a sub-part of the actions.

The resource and competency computer model (143) determine the current available resources by the user. The current available resources are determined based on list of applications, active subscriptions and the like. The hardware resources are determined from the electronic devices through provided APIs. The resource and competency computer model (143) determine the competency of the user based on the past actions performed by the user on the mobile device and the method of doing the past actions. The output provided by the resource and competency computer model (143) may be as shown in Table. 4:

TABLE 4

| | | Resource |
|---|---|---|
| User | Competencies | Availability |
| Anand | Cost Range | Prime |
| | | Membership, |
| | | Apps: |
| | | Amaz., Flip. |
| Basu | Multi-App | Apps: 1, 2, 3 |
| | | Multi- |
| | | Window |

The output obtained at the task endpoint determiner model (141) and the resource and competency computer model (143) is provided as the input to the assistance requirement matcher model (145). The assistance requirement matcher model (145) determines the assistance required for performing tasks. The assistance are the suggestions that will be given to the user on the task they are assigned. For example, they are assigned for searching on app for “speakers” the user will be given terms to search on. (“bluetooth speaker”, “home theater” etc).

FIG. 1F is a block diagram illustrating an example configuration of the step task generator and assigner model of activity management controller to determine sub-tasks to perform the common event and assign sub-tasks tasks to multiple users, according to embodiments disclosed herein, according to various example embodiments.

The step task generator and assigner model (117) assign or allocates the determined set of tasks associated with the common event to each of the user based on the competencies of the user, resources availability, application capability of the one or more applications, and the proficiency of the user. The output obtained from the chore and user comprehension model (115) is the input to the step task generator and assigner model (117).

The step task generator and assigner model (117) include a task and user matcher model (147), a resource based sub-task computation model (149), and a competency based strategy model (151), each of which may include various circuitry and/or executable program instructions configured to perform various recited/disclosed functions. The task and user matcher model (147) matches the set of tasks with the multiple users based on the competencies of the user. The task and user matcher model (147) performs the matching between the task and the competencies of the user that is suitable for the task. Further, the task is matched with user having the suitable competencies.

The resource based sub-task computation model (149) determines the amount of resources that is required for each of the task from the set of tasks requires. Further, the set of tasks is allocated to the users based on the resource availability.

The competency based strategy model (151) determines strategies required for each of the tasks that is assigned to the particular user.

The step task generator and assigner model (117) provides an output of set of tasks that is assigned to a particular user and strategies that can be provided by the user as shown in table. 5:

TABLE 5

| | | | Expediting |
|---|---|---|---|
| Task | Sub Task | Assignee | Strategies |
| Buy Items: | Buy / Rent | Anand, Chitu | Wishlist, Product |
| groceries, | Speakers | | Reviews |
| Electronics | | | |
| | Buy Snacks | Base, Dave | Poll, |

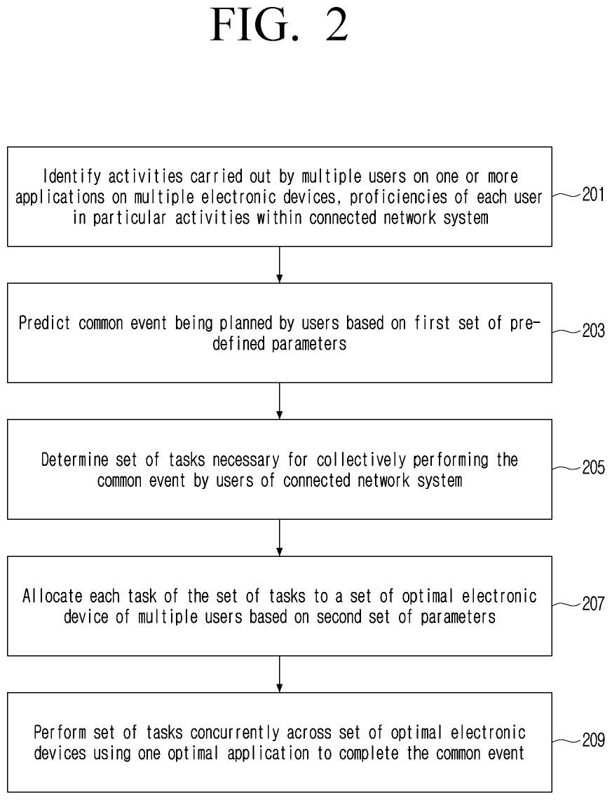

FIG. 2 is a flowchart illustrating an example method for redundancy removal and resource allocation in a connected network system, according to various example embodiments.

At block 201, the method includes identifying the activities carried out by multiple users on one or more applications on multiple electronic devices, proficiencies of each user in particular activities within the connected network system. Also, the multiple electronic devices is connected to the central apparatus.

At block 203, the method includes predicting the common event being planned by the users based on the first set of pre-defined parameters. The first set of pre-defined parameters can include, but not limited to the one or more applications used by the multiple users on multiple electronic devices, activities carried out by the multiple users on the one or more applications, and inputs provided on the one or more applications.

At block 205, the method includes, determining the set of tasks necessary for the collectively performing the common event by the users of the connected network system.

At block 207, the method includes allocating each task of the set of tasks to a set of optimal electronic devices of the multiple electronic devices of the multiple users based on the second set of parameters. The second set of parameters can include, but not limited to the competency of the user, the resource availability on the electronic device, application capability of the one or more applications of the multiple electronic devices of the multiple users, and the proficiencies of each user in particular activities.

At block 209, the method includes performing the set of tasks concurrently across the set of optimal electronic devices using the optimal application to complete the common event.

FIG. 3A is a diagram illustrating an example scenario to determine collective group tasks carried out by multiple users by multiple users collective group task discovery model, according to various example embodiments.

As shown in FIG. 3A consider four users named Anand (203), Devina (201), Chittu (205) and Basu (207) are present in a connected environment where they may be connected to the central hub. Consider the four users are planning to organize a house party and they have divided the tasks among themselves randomly.

Consider the tasks that were divided among the users manually as shown in below table. 6:

TABLE 6

| | | Using | |
|---|---|---|---|
| User | Task Taken | App | Task being done |
| Anand | Looking after any party | Amazon | Searching for “party |
| 203 | materials that need to be | | Poppers” for the party |
| | shopped for house party. | | since part of |
| | | | conversation. |
| Devina | Looking after any party | Amazon | Searches for “party |
| 201 | materials that need to be | | Poppers” for the party |
| | shopped for house party. | | since part of |
| | | | conversation. |
| Chittu | Looking for Food | Zomato/ | Starts searching “Food |
| 205 | Arrangements for the | Swiggy | App” for party boxes |
| | Party | | and prices on them |
| Basu | Preparing the guest | Samsung | Starts jotting down |
| 207 | list to invite people | Notes | names of people who |
| | to the party | | might attend the party! |

The affordance insight assembler model (113) as shown in FIG. 3B uses an AI model to determine what tasks the users are doing on the electronic devices and how the tasks being performed can be made better. For example, the affordance insight assembler model (113) triggers a notification regarding the total amount of time taken (217) to complete the redundant tasks along with redundant tasks and the smart time (219) in which the task can be completed without redundancy along with some suggestions on unique applications that can be used to perform the task, the search terms and the like. as shown in FIG. 3C. The affordance insight assembler model (113) can trigger or pop-up some of the message for joining the session and task distribution and to finish the task quickly. Also, the affordance insight assembler model (113) can ask for some of the tasks inputs (213) from the user that can be used for performing the task effectively as shown in FIG. 3D. The trigger can ask some of the inputs from the user such as budget range (231), when shopping for groceries or speakers. The trigger can be query regarding if the user is wishing for a discount (235) for a product the user is searching.

The chore and user comprehension model (115) determine the common event that is performed by the multiple users based on the one or more activities performed by the user, the one or more applications for performing the one or more activities, and the keyboard inputs provided by the user. Once, the common objective is determined, the step task generator and assigner model (117) determines the set of tasks associated the common event performed by the multiple users. The step task generator and assigner model (117) assigns or allocates each task among the set of tasks to each of the user among the multiple user based on the user competency, resource availability, and the application capability of the one or more applications in the multiple electronic devices. The task allocation is performed using the AI model. The AI model that is used to allocate the tasks is trained using a second set of parameters. The second set of parameters can include, but not limited to the competency of the user, the resource availability on the electronic device, application capability of the one or more applications of the multiple electronic devices of the multiple users, and the proficiencies of each user in particular activities. The output obtained after applying the disclosed solution may be as shown in below table 7:

TABLE 7

| | Reassigned | | |
|---|---|---|---|
| User | Task | Reason | Assistance by Engine |
| Anand | Looking for | Subscriptions of | Filters / Preferences adopted |
| 203 | Food arr. | Zomato and | from other users searches |
| | | Swiggy (“Food | |
| | | ordering apps”) | |
| Devina | Guest | Is Added and in | Mutual Consent List (Added |
| 201 | Invitation | touch with max. | people are consented by |
| | List | mutual friends of | others) |
| | | the 4 people | |
| Chittu | Party | Has Amazon | Redundancy Avoidance |
| 205 | Shopping | Prime | |
| | | Subscription | |
| Basu | Party | Has Fold Device | Redundancy Avoidance |
| 207 | Shopping | & Amazon Prime | |

The performer assistant and checker model (119) assists the users while performing the assigned tasks on the electronic devices as shown in FIGS. 3E and 3F. The performer assistant and checker model (119) can help Chittu (205) with different search terms, when Basu (207) is also searching using the same terms. Also, the performer assistant and checker model (119) helps the users in assisting through various mechanism like different term suggestion, avoiding redundancies, regular sync, awareness and the like as shown in FIG. 3F. The performer assistant and checker model (119) can provide assistance on at least one of keyboard suggestions on what to possibly type, overlays to show which app other user is working on, overlays for filter and sorting criteria's, overlays for already visited pages/sections and items in the list, raise a Poll Immediately to get consent, task achieving pie-chart on completion, auto-assign task on early completion, budget estimation aligner, show timers for taking decisions (based on tasks etc), suggestions from others (like word change, what else can we buy because out of budget), common Buckets for Collected items (like liked restaurants etc), learning task from one user and then applying it to another user! (where is the coupon menu).

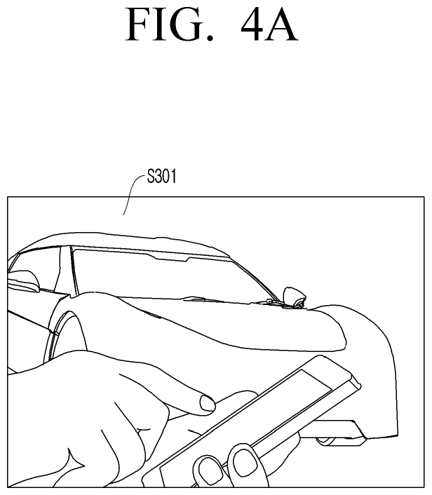

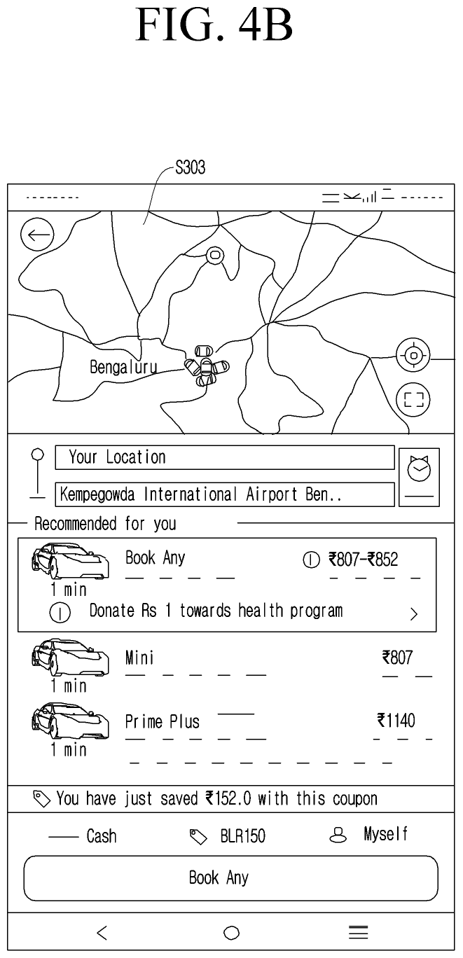

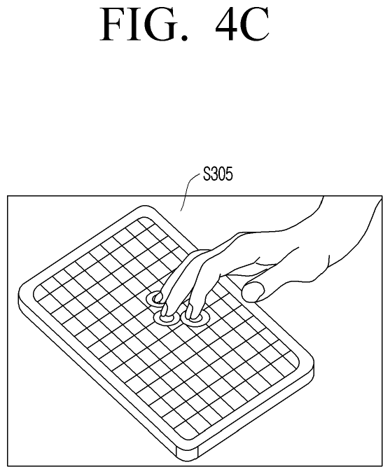

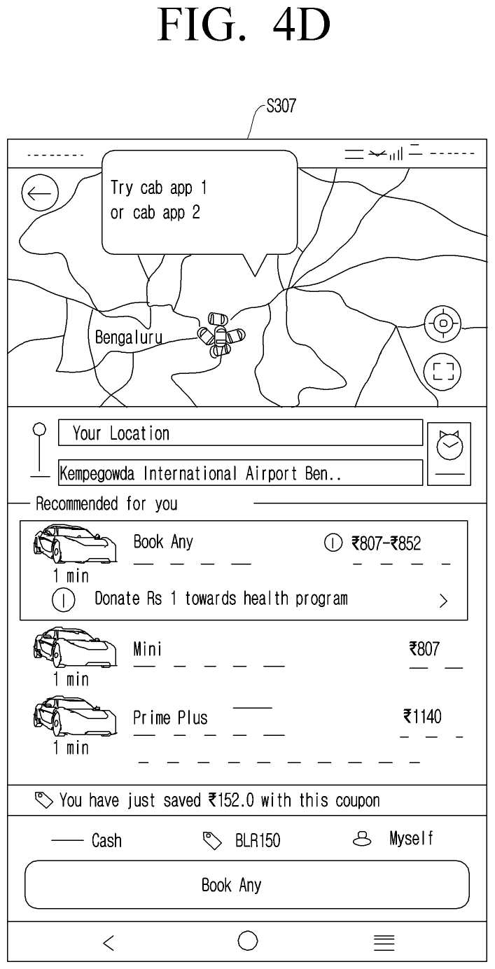

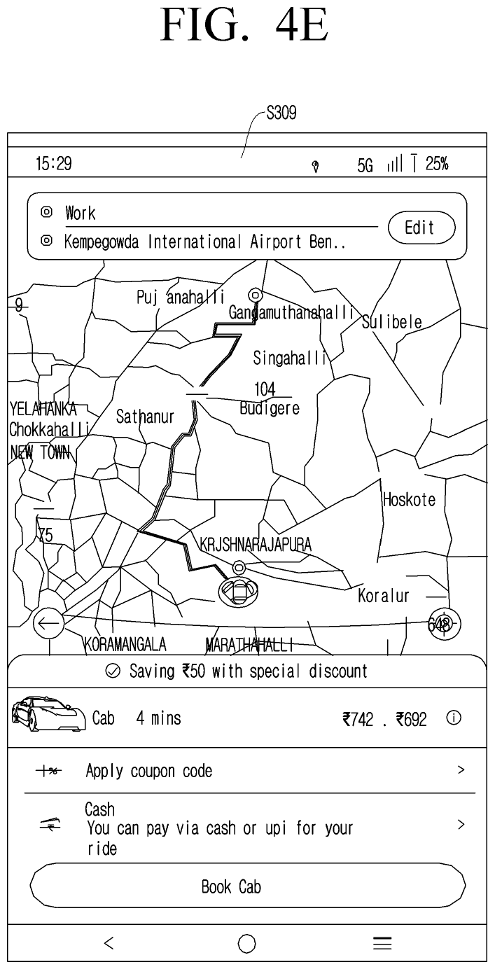

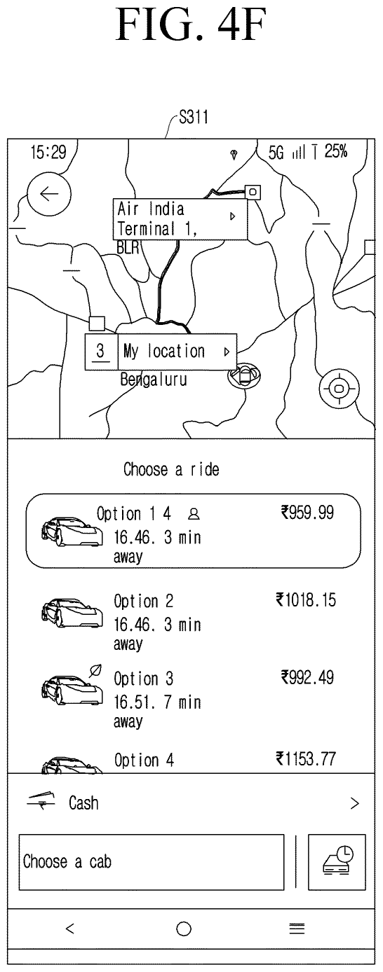

FIGS. 4A, 4B, 4C, 4D, 4E and 4F are diagrams illustrating an example scenario for redundancy removal and resource allocation while multiple users are trying to perform cab booking services, according to various example embodiments.

As shown in FIG. 4A at step S301, a user and his friends are trying to book a cab. Consider, the group of friends are present the users house and everybody starts booking the cab to airport being the destination. For example, at step S303 the user 1 is booking a cab in an application 1 as shown in FIG. 4B. At step S305, the activity management controller (109) determines the redundant activity, that is other users user 2 or user 3 is also trying to book a cab in the same application 1 and for the same source and destination based on the key presses made by the user on the electronic device as shown in FIG. 4C. However, each of the person in the group can be not aware of the same. At step S307, the activity management controller (109) of the disclosure determines the redundant activity and provides the notification to each of the other user 2 and user 3 individually to book the cab in an alternate application such as application 2 and application 3 as shown in FIG. 4D to avoid redundancy and thus optimize the tasks performed by the users. At step S309 and S311 the user 2 can try to book a cab as suggested in application 2 or application 3 as shown in FIGS. 4E and 4F.

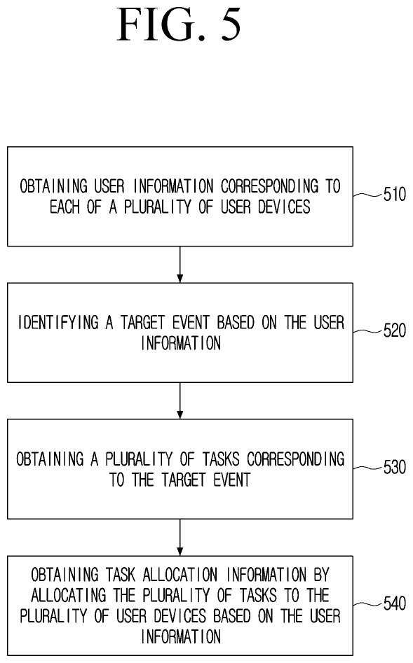

FIG. 5 is a flowchart illustrating an example method for obtaining task allocation information according to various example embodiments.

According to an example embodiment, an electronic apparatus includes at least one processor including processing circuitry and memory storing instructions.

The electronic apparatus may be a network system for redundancy removal and resource allocation. The electronic apparatus may be central apparatus (101).

The at least one processor may obtain user information corresponding to each of a plurality of user devices, identify a target event based on the user information, obtain a plurality of tasks corresponding to the target event, and obtain task allocation information by allocating the plurality of tasks to the plurality of user devices based on the user information.

The plurality of user devices may be multiple electronic devices.

The user information may refer to information associated with a user or a user device. The user information may refer to data related to activities performed using a user device. The user information may refer to information obtained from interactions between a user and an electronic device.

User information may refer to information related to application usage of a user device or performance of a user device. User information may be described as user data, user-related information or user context information.

The target event may be a common event identified from the plurality of user devices. Target event may refer to an event corresponding to actions or behaviors associated with a plurality of user devices. Target event may refer to an event commonly identified from activities performed using a plurality of user devices. The target event may refer to an event determined as being common among a plurality of user devices based on user information. The target event may be described as a common event, a collective event or a shared event.

For example, the user information may include at least one of activities of the plurality of user devices or parameters of users.

The activities may be data obtained while users use the plurality of user devices. The activities may refer to data representing actions performed by users using the plurality of user devices.

The activities may refer to information obtained while users operate applications or functions of the plurality of user devices. The activities may refer to information obtained from interactions of users with applications executed on the plurality of user devices. The activities may refer to data generated while users operate applications or functions of the plurality of user devices. The activities may be described as user activity data, user behavior data, application usage data, application history information or user interaction data.

The parameters may be data related to a user or a user device. The parameters may refer to information related to a user or a user device used for allocating tasks. The parameters may refer to data indicating capabilities of a user or performance of a user device.

The parameters may refer to information associated with characteristics of a user or resources of a user device.

The characteristics of a user may refer to data estimated based on past activities or application usage patterns of the user. The characteristics of a user may refer to information derived from historical interactions between the user and a user device. The characteristics of a user may include at least one of user proficiency inferred from past application usage, preference of the user derived from search history, frequency of use of specific applications, or interaction patterns of the user with applications.

The resources of the user device may refer to hardware or software capabilities available in the user device for performing tasks. The resources of the user device may refer to functional capabilities of the user device that enable execution of applications or operations. The resources of the user device may refer to performance-related features of the user device used to support task execution. The resources of the user device may include at least one of processing capability of the user device, available memory of the user device, screen capability of the user device, connectivity capability of the user device, or capability of applications executed on the user device. The resources of the user device may be described as device resources, device capabilities or device performance resources.

The parameters may include at least one of user proficiency in activities, capability of a user device, resource availability of a user device, or capability of an application executed on the user device.

The parameters may include at least one of user parameters, device capability information or resource information.

The at least one processor may identify the target event based on the activities of the plurality of user devices, and allocate the plurality of tasks to the plurality of user devices based on the parameters of users.

The at least one processor may identify at least one redundant activity from the at least one of activities, remove the at least one redundant activity from the at least one of activities, and identify the target event based on the activities from which the redundant activity is removed.

The redundant activity may refer to an activity that is performed by more than one user device for achieving a same purpose. The redundant activity may refer to an activity that overlaps with another activity performed by another user device. The redundant activity may refer to an activity that duplicates an activity performed by another user device in relation to a same event. The redundant activity may include at least one of performing a same search on different user devices, accessing a same application for a same task on multiple user devices, executing a same operation on multiple user devices, or performing repeated actions related to a same event. The redundant activity may be described as a duplicate activity, an overlapping activity or a repetitive activity.

The electronic apparatus may include a communication interface, The at least one processor may identify the plurality of user devices based on a communication protocol corresponding to the communication interface. The communication protocol may be network protocol(s).

The communication protocol may include at least one of Wi-Fi, Bluetooth, Near Field Communication (NFC), or Ultra-Wide Band (UWB), and the plurality of user devices may be identified as nearby devices through device discovery performed using the communication protocol.

The plurality of user devices may be identified as nearby devices using the communication protocol. The proximity of the plurality of user devices may be determined based on at least one of received signal strength, device discovery signals, device advertisement packets, or distance estimation obtained through the communication protocol.

The electronic apparatus may include a display. The at least one processor may control the display to display the task allocation information.

The task allocation information may refer to information indicating assignment of tasks to the plurality of user devices. The task allocation information may refer to information representing results of allocating tasks corresponding to the target event to the plurality of user devices. The task allocation information may refer to information identifying which a task is assigned to which user device.

The task allocation information may include at least one of a first result of allocating a first task to a first user device, a second result of allocating a second task to a second user device, mapping information between tasks and user devices, or execution order information of tasks. The task allocation information may be described as task assignment information, task distribution information or task mapping information.

The at least one processor may obtain first user information corresponding to a first user device of a first user, obtain second user information corresponding to a second user device of a second user, and identify the target event based on the first user information and the second user information.

The at least one processor may obtain a first task and a second task corresponding to the target event, allocate the first task to the first user device, allocate the second task to the second user device, and obtain the task allocation information including a first result of allocating the first task to the first user device and a second result of allocating the second task to the second user device.

According to an example embodiment, a method for controlling an electronic apparatus include obtaining user information corresponding to each of a plurality of user devices (510), identifying a target event based on the user information (520), obtaining a plurality of tasks corresponding to the target event (530), and obtaining task allocation information by allocating the plurality of tasks to the plurality of user devices based on the user information (540).

Target event may be a common event identified from the plurality of user devices.

The user information may include at least one of activities of the plurality of user devices or parameters of users.

The activities may be data obtained while users use the plurality of user devices, and the parameters may be data related to a user or a user device.

The identifying the target event may include identifying the target event based on the activities of the plurality of user devices, and the obtaining the task allocation information may include allocating the plurality of tasks to the plurality of user devices based on the parameters of users.

The various actions, acts, blocks, steps, or the like in the FIG. 1A though FIG. 5 are performed in the order presented, in a different order, or simultaneously. Furthermore, in various embodiments, some of the actions, acts, blocks, steps, or the like are omitted, added, modified, skipped, or the like without departing from the scope of the disclosed method.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An electronic apparatus comprising:
at least one processor comprising processing circuitry; and
memory storing instructions,
wherein the instructions, when executed by at least one processor, individually and/or collectively, cause the electronic apparatus to:
obtain user information corresponding to each of a plurality of user devices,
identify a target event based on the user information,
obtain a plurality of tasks corresponding to the target event, and
obtain task allocation information by allocating the plurality of tasks to the plurality of user devices based on the user information.

2. The electronic apparatus as claimed in claim 1, wherein the target event includes a common event identified from the plurality of user devices.

3. The electronic apparatus as claimed in claim 2, wherein the user information includes at least one of activities of the plurality of user devices and/or parameters of users.

4. The electronic apparatus as claimed in claim 3, wherein the activities include data obtained while users use the plurality of user devices, and
wherein the parameters include data related to a user or a user device.

5. The electronic apparatus as claimed in claim 3,
wherein the instructions, when executed by at least one processor, individually and/or collectively, cause the electronic apparatus to:
identify the target event based on the activities of the plurality of user devices, and
allocate the plurality of tasks to the plurality of user devices based on the parameters of users.

6. The electronic apparatus as claimed in claim 5,
wherein the instructions, when executed by at least one processor, individually and/or collectively, cause the electronic apparatus to:
identify at least one redundant activity from the at least one of activities,
remove the at least one redundant activity from the at least one of activities, and
identify the target event based on the activities from which the redundant activity is removed.

7. The electronic apparatus as claimed in claim 1, further comprising:
a communication interface comprising communication circuitry;
wherein the instructions, when executed by at least one processor, individually and/or collectively, cause the electronic apparatus to:
identify the plurality of user devices based on a communication protocol corresponding to the communication interface.

8. The electronic apparatus as claimed in claim 1, further comprising:
a display;
wherein the instructions, when executed by at least one processor, individually and/or collectively, cause the electronic apparatus to:
control the display to display the task allocation information.

9. The electronic apparatus as claimed in claim 1,
wherein the instructions, when executed by at least one processor, individually and/or collectively, cause the electronic apparatus to:
obtain first user information corresponding to a first user device of a first user,
obtain second user information corresponding to a second user device of a second user, and
identify the target event based on the first user information and the second user information.

10. The electronic apparatus as claimed in claim 9,
wherein the instructions, when executed by at least one processor, individually and/or collectively, cause the electronic apparatus to:
obtain a first task and a second task corresponding to the target event,
allocate the first task to the first user device,
allocate the second task to the second user device, and
obtain the task allocation information including a first result of allocating the first task to the first user device and a second result of allocating the second task to the second user device.

11. A method for controlling an electronic apparatus, comprising:
obtaining user information corresponding to each of a plurality of user devices,
identifying a target event based on the user information,
obtaining a plurality of tasks corresponding to the target event, and
obtaining task allocation information by allocating the plurality of tasks to the plurality of user devices based on the user information.

12. The method claimed in claim 11, wherein the target event includes a common event identified from the plurality of user devices.

13. The method claimed in claim 12, wherein the user information includes at least one of activities of the plurality of user devices and/or parameters of users.

14. The method claimed in claim 13, wherein the activities include data obtained while users use the plurality of user devices, and
wherein the parameters are data related to a user or a user device.

15. The method claimed in claim 13, wherein the identifying the target event comprises:
identifying the target event based on the activities of the plurality of user devices, and
wherein the obtaining the task allocation information comprises:
allocating the plurality of tasks to the plurality of user devices based on the parameters of users.
